(19) United States
(12) Patent Application Publication
(10) Pub. No.: US 2021/0115715 A1
(43) Pub. Date: Apr. 22, 2021

(54) Assembly of Door and Door Frame With Reduced Risk of Squeeze Caused Injuries

(71) Applicant: Teem Door Consult AS, Kjeller (NO)

(72) Inventors: Morten Kaspersen, Kjeller (NO); Edgar Moe, Löken (NO)

(21) Appl. No.: 16/326,479

(22) PCT Filed: Aug. 21, 2017
(86) PCT No.: PCT/NO2017/050207

§ 371 Date: Feb. 19, 2019

(30) Foreign Application Priority Data
Aug. 19, 2016 (NO) 20161318
May 9, 2017 (NO) 20170758

(51) Int. Cl. E05D 7/00; E05D 3/12; E05D 11/00; E06B 1/52; E06B 3/34; E06B 3/88; E06B 7/36

(52) U.S. Cl. CPC E05D 7/0009; E05D 3/12; E05D 11/0054; E06B 1/16; E06B 3/34; E06B 3/88; E06B 7/367; E06B 1/52

(57) ABSTRACT

Assembly of door and doorframe, the door at a back vertical edge is hinged to a doorframe hinge side of the doorframe using door hinges at the upper and lower end of the door. The doorframe hinge side is designed with a cavity while a cover is rigidly attached to the door hinges up and down. The cover has a bore pivotally attached to cover hinges with vertical pivotal axis at the doorframe hinge side having a dimension adapted to be received within said cavity in the doorframe hinge side when the door is shut The cover has a curvature with a convex outer surface having the shape of a cylinder surface of a vertical imaginary cylinder, while the bore is so positioned that it forms a center axis in the imaginary cylinder and that this center axis is positioned externally in relation to the cavity.

### BACKGROUND

The disclosed embodiments concern an assembly of a door and a doorframe, and more particularly, the disclosure concerns an assembly of a door and door frame which exhibits reduced risk of squeeze caused injuries to fingers.

In office buildings, commercial buildings and industrial buildings but particularly in private buildings finger injuries frequently occur caused by fingers being squeezed at the back edge of doors being closed, that being whether the door is closed intentionally or unintentionally.

Children in particular are particularly exposed for such injuries in conjunction with their play. Oftentimes, the person closing a door which is only half-open is not aware that there is a person at the opposite side of the door exposed to the risk of having his or hers fingers squeezed.

A number of efforts have been suggested to eliminate said problems, using mechanical means and/or electronical means. Electronical means are primarily suggested in connection with car doors, less frequently for doors in buildings and homes.

Among mechanical means which have been suggested, reference is made in particular to US Patent Application Publication No. 2012/0227327, which comprises a system that may be compared to a back spiral of a college notebook. The system may be well functioning if the spirals or coils are arranged sufficiently close but appears to be vulnerable for wear and external influence and not particularly aesthetically attractive.

KR 2016-0087 107 teaches a solution for a door having a doorframe where the door at its hinged side is provided with a curved unit (adapter) which is pivotal into and out from a cured cover which in turn is pivotal into and out from a hollow doorframe to thereby reduce the risk for squeeze caused injuries at the back edge of the door during its closing. The door may be opened up to about 135 degrees but hits the wall with an edge in this position which represents a squeeze risk during opening of the door as well as a risk for damaging wall and door. In addition, using this solution, there is no room for list to cover the doorframe, which is typically used in private home buildings.

### SUMMARY

In one embodiment, the disclosure provides a door, in combination with a doorframe adapted thereto, providing reduced or substantially eliminated risk for finger injuries at the back edge of the door during closing, that being whether the door is closed intentionally or unintentionally, e.g. caused by a wind draft and whether it is closed rapidly or slowly. Also provided is a door, in combination with a doorframe adapted thereto, which may be opened more than 90 degrees, still with reduced risk of finger injuries also when the door is opened more than 90 degrees.

Additionally, an embodiment may use means which are not exposed to substantial wear or influence and which provides an adequate solution as well for private homes as for hotels, office buildings etc.

The disclosed embodiments may also use means which are aesthetically attractive, preferably that the door and doorframe generally appear as conventional.

As demonstrated by the description and drawings there is no place at the back edge of the door where fingers can get access to areas that are closed when the door is closed and thereby be squeezed. This does not mean that it is impossible to have fingers squeezed in such a door, more particularly at the front edge of the door but this problem is minor of several reasons, partly because these injuries seldom are as severe as those at the back edge due to the proximity of the latter to the door hinges, partly because it is easier to see a person at the front edge of the door than one at the back edge, when the person closing the door is on the opposite side thereof.

The risk of finger injuries is thus significantly reduced compared to what is the case for conventional doors.

The disclosed embodiments are aesthetically adequate and do not comprise parts that are particularly exposed to wear and tear, different from e.g. the solution according to US 2012/022 7327, which cannot be said to provide an aesthetically attractive solution and which additionally necessarily is subjected to significant wear and tear. Furthermore, it provides improved opening and less risk for injury compared with the design shown by KR 2016-0087 107.

Below, the terms “doorframe” and “doorframe hinge side” are used somewhat varying. It should be understood that the functionality discussed in this publication with reference to the doorframe, is consistently related to the vertical hinge side of the doorframe to the extent this is different from opposite frame side or horizontal frame sides.

The disclosed embodiments allow opening a door according more than 90 degrees and if desired up to 180 degrees. At the same time, the design allows application of a list that covers the doorframe, which is commonly used for doors in private homes.

A cover that typically extends the entire door height covers the opening into the area in which fingers would easily be squeezed when the door is again closed. The cover is attached to the upper and lower door hinge and rotates with these hinges. On the side visible from the room, the cover has a surface that constitutes a segment of a cylinder, which effectively seals towards the doorframe as well as towards the door in any open position of the door.

### BRIEF DESCRIPTION OF THE DRAWINGS

Below, the present invention is described in further detail though exemplifying embodiments illustrated by the accompanying drawings, where

FIG. 1A shows an overview of the present door and doorframe.

FIGS. 1B-1C show part of a doorframe 10 according to a first embodiment, and specifically the hinge side 11 of a doorframe 10.

FIGS. 2A-2B show a door blade adapter according to a first embodiment.

FIGS. 3A-3B show a cover for a door according to a first embodiment.

FIGS. 4A-4B show a door hinge suitable for use to hinge a door according to a first embodiment.

FIG. 5A shows an assembly of the above components in a position where the door is shut.

FIG. 5B shows an assembly of the above components in a position where the door is opened to 90 degrees.

FIG. 5C shows an assembly of the above components in a position where the door is opened to 180 degrees.

FIGS. 6A-6B show an assembly of a doorframe according to a second embodiment.

FIG. 7 shows a cross-section of a door blade adapter according to the second embodiment.

FIG. 8 shows a cross-section of a cover for a door according to said second embodiment.

FIG. 9 shows a cross-section of a door hinge suitable for use with the details according to the FIGS. 6-8.

FIG. 10A shows an assembly of the components shown in the FIGS. 6-9 in a position where the door is closed.

FIG. 10B shows an assembly of the components shown in the FIGS. 6-9 in a position where the door is opened to 90 degrees.

FIG. 10C shows an assembly of the components shown in the FIGS. 6-9 in a position where the door is opened to 180 degrees.

FIGS. 11A-11C shows details of a third embodiment.

FIGS. 12A-12B show assembly of details from the embodiment shown in the FIGS. 11A-11C.

### DETAILED DESCRIPTION

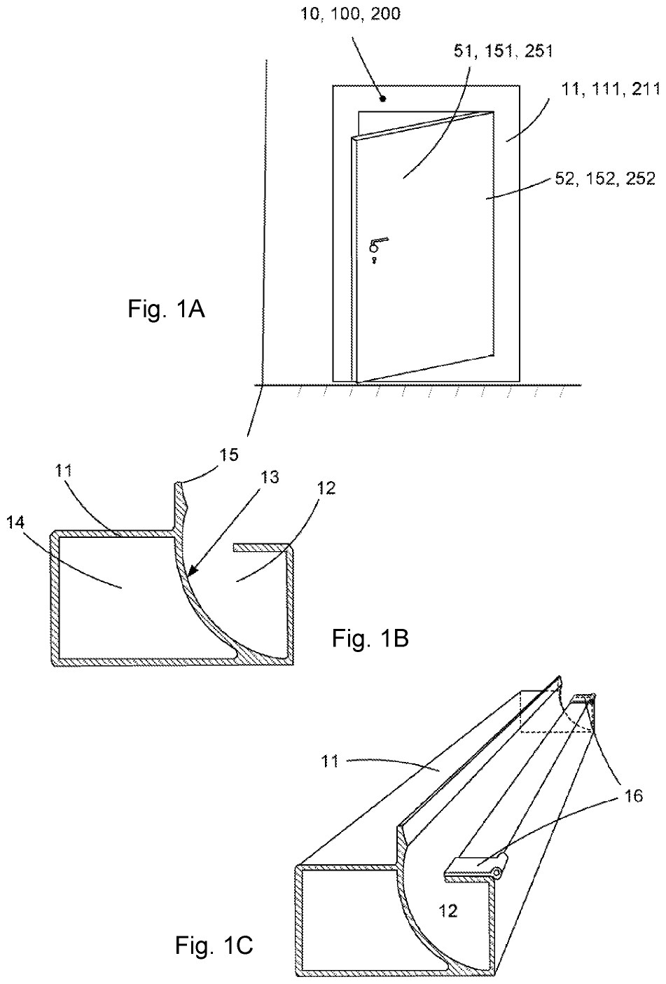

FIG. 1A generally shows a door 51, 151, 251 in a doorframe 10, 100, 200, the doorframe having a hinge side 11, 111, 211 to which the back edge 52, 152, 252 of the door is hinged.

FIG. 1B shows a vertical section of a doorframe 11 (the hinge side of the frame) according to a first embodiment. The vertical doorframe of the opposite side can have a simpler profile since there is no requirement for the corresponding functionality to that side of the frame.

The doorframe hinge side exhibits a cavity 12 extending the height of the doorframe, which is open and which in one embodiment comprises a partition wall with a concave curved surface 13 towards the cavity 12. The doorframe furthermore exhibits a cavity 14 which is closed and which does not have a technical function other than contributing to providing desired shape and dimension to the doorframe. A small flange 15 extends out from the open cavity 12 as an extension of the curved surface 13.

FIG. 1C shows in perspective the doorframe 11 and also shows that it is provided with two cover hinges 16, one upper and one lower, the function of which being to pivotally hold a cover to be described below. As apparent from FIG. 1C the cover hinge 16 is arranged externally in relation to the cavity 12 of the doorframe and the dimension, shape and exact position of the cover hinge will affect the properties somewhat as discussed in some detail below.

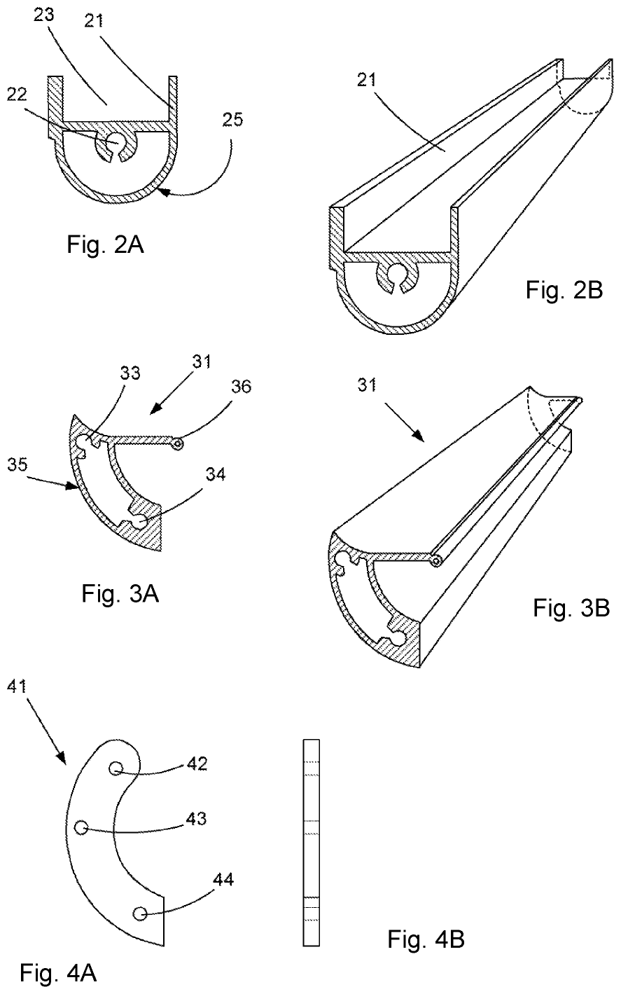

FIG. 2A shows a cross-section of a door blade adapter 21 according to an embodiment of the disclosure. When an adapter is employed, it is attached to the back edge of a door blade to give the door blade desired shape towards the doorframe hinge side. By back edge of a door blade is understood the edge of the door blade facing the side of the doorframe at which the door is hinged. The door blade adapter has a bore 22 suitable for pivotal attachment to a door hinge as described below. After assembly, the bore 22 constitutes a rotational axis around which the door can be rotated during opening and closing. A part 25 of the door blade adapter 21 has a convex curvature in the entire extension of the door blade adapter.

FIG. 2B shows the door blade adapter in perspective. Typically, it has a vertical extension corresponding to the door height.

FIG. 3A shows a cross-section of a cover 31 according to the disclosure. The function thereof is primarily to enable an opening of the door to more than 90 degrees while maintaining the inherent safety feature of reduced risk for finger injuries. The cover has a convex outer surface 35, which conveniently can have the same curvature as the inner curved surface 13 of the doorframe. In addition, it exhibits bores 33 and 34 suitable for being attached to a door hinge as described below. Finally, in a flange shaped part it has a bore 36 suitable for pivotal attachment to the doorframe using its cover hinges 16. After assembly, the bore 36 constitutes a pivotal axis around which the cover 31 can be rotated in relation to the doorframe 11, at least when the door is opened more than 90 degrees and when it is closed from such an open position. The charactering feature of the cover is the positioning of the bore 36 in relation to the curved surface 35. The curved surface 35 has the shape of a segment of a cylinder surface, which can be regarded as constituting part of an imaginary cylinder and the bore 36 is positioned such that it forms a centre axis in the said imaginary cylinder.

FIG. 3B shows the cover 31 in perspective.

FIG. 4A shows a top view of a door hinge 41 of which there will be one at the top of the door and one at the bottom of the door, providing attachment to the door blade adapter 21 as well as to the cover 31. The door hinge 41 exhibits three holes, 42, 43 and 44. The hole 42 will subsequent assembly be attached concentrically with the bore 22 of the door blade adapter, typically using a common vertical bolt through the hole 42 and partly penetrating the bore 22, so that the door blade adapter and thereby the door can be rotated in relation to the door hinge and thereby in relation to the doorframe in a per se conventional manner. When assembled, the bore 22 and the hole 42 are thus commonly referred to as a pivotal axis 22, 42.

The hole 43 in the door hinge will after assembly be concentrically with the bore 34 in the cover 31 and the hole 44 will correspondingly be arranged concentrically with the bore 34 in the cover 31. The door hinge 41 and the cover 31 are rigidly attached to one another at these positions at the upper and lower ends of the door using screws or the like.

FIG. 4B is a side sectional view of the door hinge 41, showing the holes 42, 43, and 44 using broken lines.

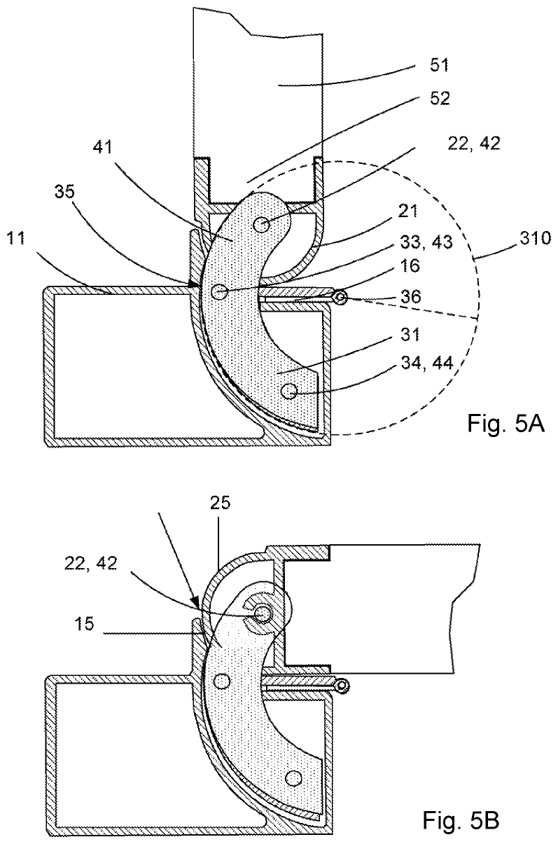

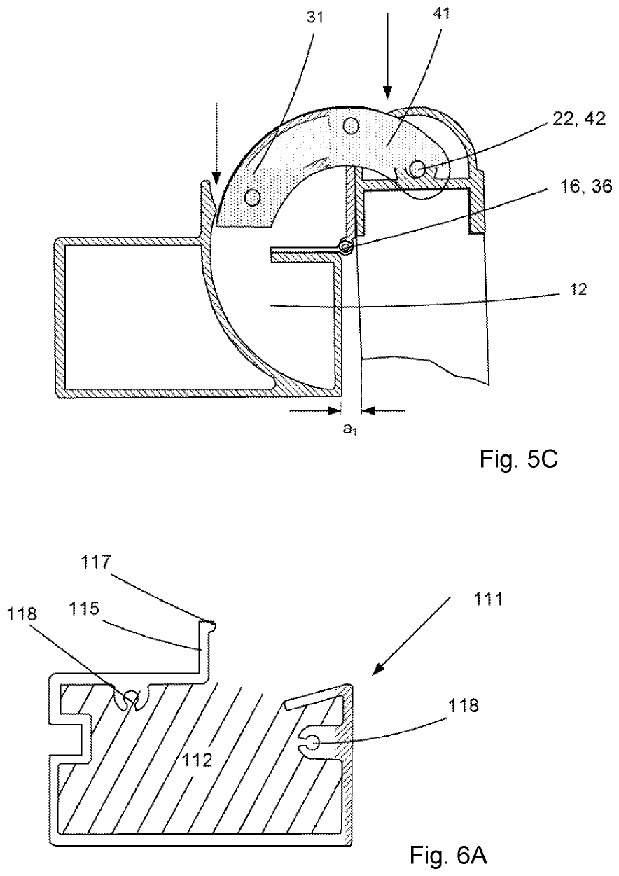

FIG. 5A shows an assembly of all the above components of the first embodiment in a closed position of the door 51. The illustration shown is at the upper hinge of the door. The door hinge 41 is shown as slightly transparent to not hide the cover 31 positioned behind (below). As explained earlier, attachment hole 43 is positioned aligned with and attached to the bore 33, attachment hole 44 is positioned aligned with and attached to bore 34 while cover hinge 16 and bore 36 correspondingly are positioned mutually concentrically and pivotally attached to one another. The hole 42 is aligned with the bore 22 and these are pivotally attached to one another.

FIG. 5A furthermore illustrates the fact that the positioning of the bore 36 is chosen to make it a centre axis in an imaginary cylinder 310 defined by the curvature 35 of the cover 31. Finally, FIG. 5A shows that the pivotal axis 36 for the cover 31 about the cover hinge 16 is external in relation to the doorframe 11 and more specifically in relation to the doorframe cavity 12. The significance of this is discussed below.

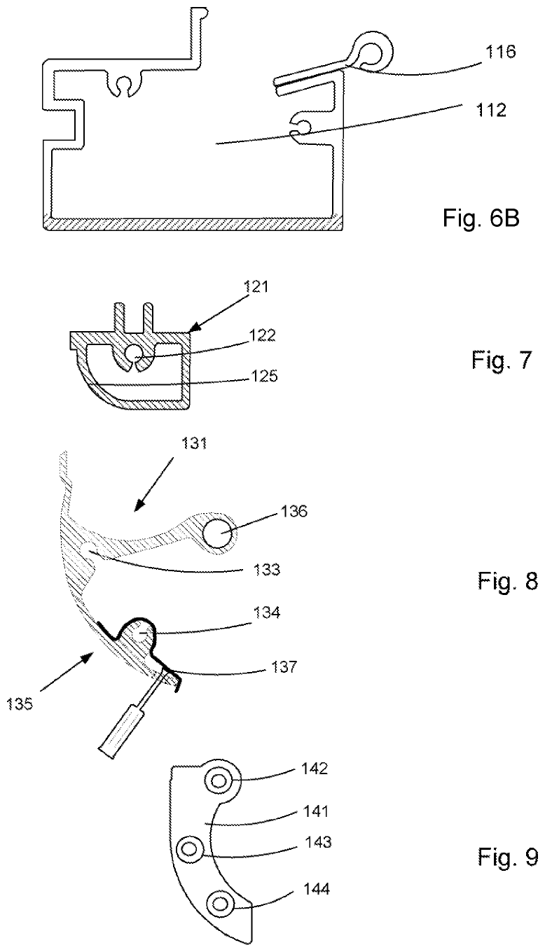

In FIG. 6B the door is shown in a position open 90 degrees from its closed position by rotation about the axis shown at 22, 42. The other parts of the assembly are as shown in FIG. 5A. An arrow in FIG. 5B shows the point at which risk for squeeze of fingers would normally occur. Due to the cooperating curvature of door blade adapter and doorframe, included the flange part 15 of the doorframe, there is no room for a finger between door and doorframe, independent of the door position at an opening of up to 90 degrees in relation to a closed door.

In FIG. 5C, the door shown in FIGS. 5A and 5B has been opened to about 180 degrees. This has happened from the position shown in FIG. 5B by a rotation also in the connection between the cover's 31 bore 36 and the cover hinge 16, additional to the rotation between door 51 and door hinge 41 (shown in FIG. 5B). By rotation about the cover hinge 16, the cover 31 and thereby the door hinge 41 is pulled at least partially out of the cavity 12 of the doorframe in which it resides when the door is closed. As again shown by (vertical) arrows there is no room for fingers to enter zones in which the fingers could have been squeezed when the door is again closed.

FIG. 5C furthermore shows that a distance a₁ between the doorframe 11 and the door is maintained also when the door is opened to 180 degrees, caused by the position of the pivotal axis 36 for the cover, externally in relation to the cavity 12 of the doorframe. While a modest distance a₁ is shown in FIG. 5C, this distance can easily be increased by an adjusted positioning or dimensioning of the cover hinge 16 and a corresponding adaptation of the cover 31, so that the pivotal axis 36 is moved further away from the doorframe. This may have an impact on safety but also for the possibility of attachment of a list to partly cover the doorframe without interference between door and list when the door is opened all the way to 180 degrees,

While the above description indicated that the first 90 degrees of opening takes place solely by a rotation about the axis at 22, 42 and that further opening solely takes place by rotation about the axis at 36, in practice it is possible and within the scope of the present disclosure that an initial rotation about the axis 36 takes place before the door has been opened 90 degrees, and even that the first part of the opening sequence takes place solely by rotation at the axis 36 and, in such case, that the further opening takes place by a subsequent rotation about the axis at 22, 42. If desired the above can be controlled by different means, such as e.g. using a controlled pivotal friction at the axis 22, 42 which is lower than that at the axis 36 or vice versa. Spring counteracted opening may also be employed so that the last part of the opening meets a higher counteracting force than the first one, e.g. with increased resistance from 135 degrees compared to the resistance up to this opening angle. This, however, is not significant in relation to the general functionality and is therefore not discussed in further detail here.

Naturally, it is not a prerequisite that the door allows an opening up to 180 degrees, while it is significant that it can be opened to more than 90 degrees and even significantly more, without sacrificing the inherent degree of safety offered.

We now refer to an embodiment which is somewhat different from the one above but using the same general principle and offering the same inherent properties.

Thus, FIG. 6A shows a cross-section of a doorframe hinge side 111, which is open into a cavity 112 (shaded). This doorframe has just one large open cavity, no additional closed cavity. Furthermore, it has an extending flange 115, i.e. a flange that extends in a direction away from the cavity 112 and a laterally extending stop flange 117 from the flange 115, extending in over the passage into the cavity 112. FIG. 6A also shows bores 118 for attachment of the frame—the vertical parts thereof—against the horizontal upper part of the doorframe and correspondingly against the lower horizontal part (doorsill) of the doorframe.

FIG. 6B shows the same as FIG. 6A but shows additionally where on the frame profile the cover hinge 116 for the door hinge is attached. The profile surface at the cover hinge is inclined of aesthetical reasons; it does not have to be inclined. Additionally, FIG. 6B shows that the cover hinge 116 arranged in a manner in which the pivotal point for the cover is well outside the cavity of the frame 111.

FIG. 7 shows a cross-section of a door blade adapter 121 serving same purpose as the door blade adapter 21 shown in FIGS. 2A-2B. It comprises a bore 122 and a convex outer surface 125, which however only extends about half the surface facing away from the door blade after having been attached to a door blade. In function, it is equivalent with the earlier shown design. In the same manner as for the door blade adapter 21 shown in FIG. 2, the door blade adapter 121 has an extension that typically corresponds to the height of the door to which it is to be mounted.

FIG. 8 shows a cross-section of a cover 131. It exhibits bores 133 and 134 intended to be attached to a door hinge by means of suitable attachments, such as a screw, and a bore 136 suitable for pivotal attachment to the cover hinge 116 on the doorframe. The cover 131 has a convex surface 135 corresponding to surface 35 on cover 31. The cover 131 additionally, at the end intended to be furthest into the cavity of the door frame, a lateral stopper 137 which in cooperation with stop flange 117, is arranged to function as a door stopper, so that the cover cannot be pulled out of the cavity 112 entirely. The stopper 137 is typically soft and flexible so that it can easily be pushed aside, e.g. by a screwdriver, to release the cover from the frame, as illustrated by FIG. 8. For this purpose small holes are arranged in the cover, possible sealed by plastic plugs or the like. The stopper 137 is typically not part of the cover, but a separate part, conveniently in metal, with limited vertical extension, attached to the cover e.g. in connection to a bore, such as bore 134. Having the possibility of pushing the stopper aside is important in relation to assembly, disassembly, repair work etc. but has nothing to do with the daily operation of the door.

The door blade adapter 121 and the cover 131 has, similarly to the corresponding 21 and 31 respectively, an extension that corresponds the height of a door. All these components, which have a uniform cross-section along their length (or height), can be manufactured by extrusion even if that is not a requirement. The material can typically be a synthetic material, composite material or light metal. The doorframe is typically manufactured in aluminium but can also be manufactured in other materials.

FIG. 9 shows a door hinge 141 principally equal with the door hinge 41 shown in FIG. 4 and reference is made to FIG. 4 with regard to the functionality of the door hinge 141

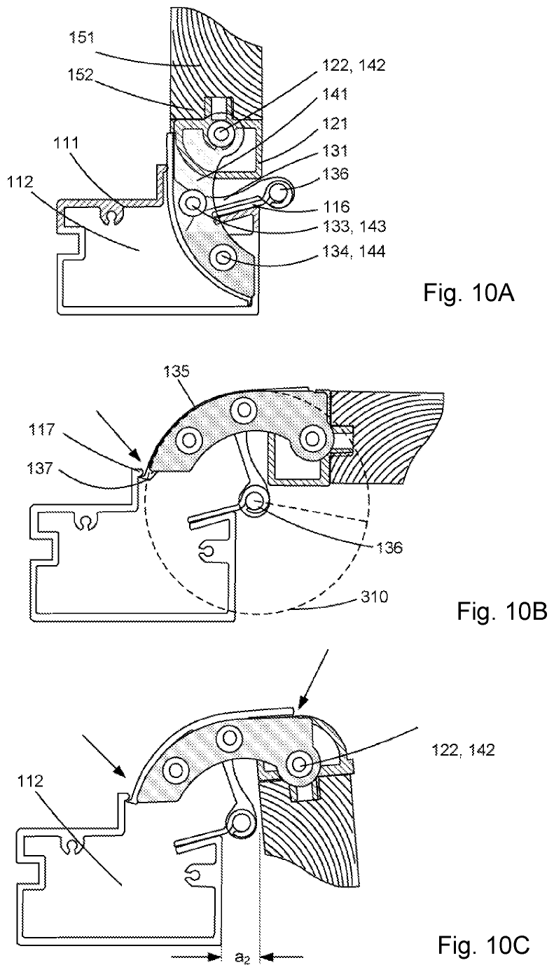

FIG. 10A shows a top view of an assembly of the components shown in the FIGS. 6-9 together with a part of a door 151, the door being in a closed position. The door hinge 141 is shown slightly transparent in order not to completely hide the parts behind (below). The door hinge 141 is rigidly attached to cover 131 at the points shown as 133, 143 and 134, 144. In addition, the door hinge 141, by its hole 142, is pivotally attached to the door blade adapter 121 in the bore 122 in what is designated a pivotal axis 122, 142. The cover 131 is pivotally attached to the cover hinge 116 on the frame 111 about an axis defined by the bore 136.

In FIG. 10B the door from FIG. 10A is shown in a position open about 90 degrees by rotation about the axis defined by the bore 136. The arrow illustrates that the potentially dangerous point for squeeze injuries not is large enough for a finger since the curvature of the cover 131, its convex surface 135, only leaves a minimal passage between the cover 131 and the doorframe hinge side 111 in all positions of the former, ensured by the fact that the axis 136 is positioned as a centre axis in an imaginary cylinder 310 which the curved surface 135 of the cover forms a segment of. FIG. 10B furthermore shows how the movement of the cover is stopped when the stopper 137 on the cover contacts the flange 117 on the doorframe.

In FIG. 10C the door from FIGS. 10A and 10B is shown opened about 180 degrees by a rotation of about 90 degrees about the axis 122, 142 in addition to the rotation shown in FIG. 10B. As for FIG. 5C is illustrated that there is a distance a₂ between the door and the doorframe also when the door is opened even 180 degrees.

For the embodiment according to the FIGS. 10A to 10C, as commented for the embodiment shown in FIGS. 5B to 5C, it is not important at which pivotal axis the rotation starts or if it occurs simultaneously/concurrently at both pivotal axes. In this respect, there is no significant difference between the embodiments shown in FIGS. 1-5 compared to the one shown in FIGS. 6-10.

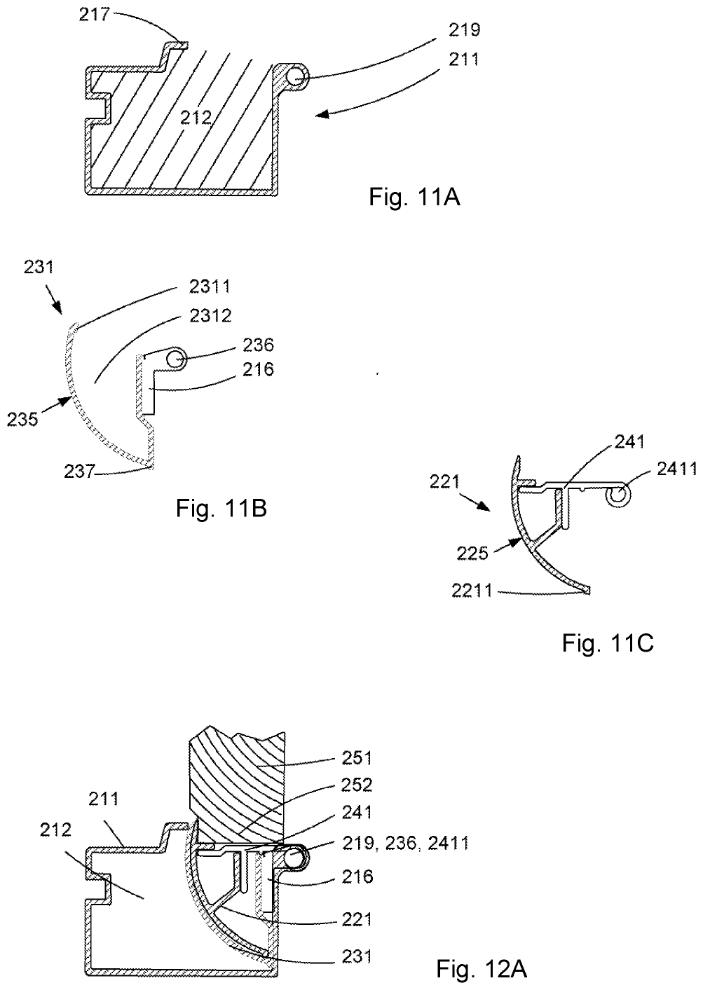

FIG. 11A shows a doorframe 211 with a cavity 212 (shaded) according to yet another embodiment. Again, the frame is designed to hinge a cover in a point externally in relation to the cavity 212 of the doorframe. The doorframe 211 has a longitudinal, preferably through bore 219 for pivotal attachment of door and cover. The frame has a laterally extending flange, extending in over the passage into the cavity 212 with same function as flange 117 shown in FIG. 6A, namely to stop the movement of a cover. A difference from the earlier shown embodiments is that the frame 211 itself exhibits a bore deciding where a rotational axis is positioned.

FIG. 11B shows an assembly of a cover 231 and a cover hinge 216, the latter with a bore 236 of same cross-section as the bore 219 in the doorframe. At a “front” end the cover has an inwardly oriented edge 2311 arranged cooperate with a door blade adapter attached to the door. The cove has a shape defining an open cavity 2312 suitable for receiving an accommodated door blade adapter. The cover 231 has a curved surface 235, which constitutes part of a cylinder surface, also called a part-cylindrical surface. Finally, FIG. 11B shows a small extending stop flange 237 suitable for being received by the flange 217 on the door frame 111 when the door is opened to or near to 180 degrees.

FIG. 11C shows an assembly of a door hinge 241 and a door blade adapter 221. At a “back end”, the door blade adapter exhibits an outwardly oriented edge 2211, arranged to cooperate with the edge 2311 on the cover 231 when the door is opened more than 90 degrees. The door hinge 241 has at least one, more typically two attachment ear(s) with bores 2411 of a cross-section similar to the bores 219 and 236. The door blade adapter 221 has a curved outer surface 225 with shape of a part of a cylinder surface of same or substantially same curvature as the surface 235 of the cover.

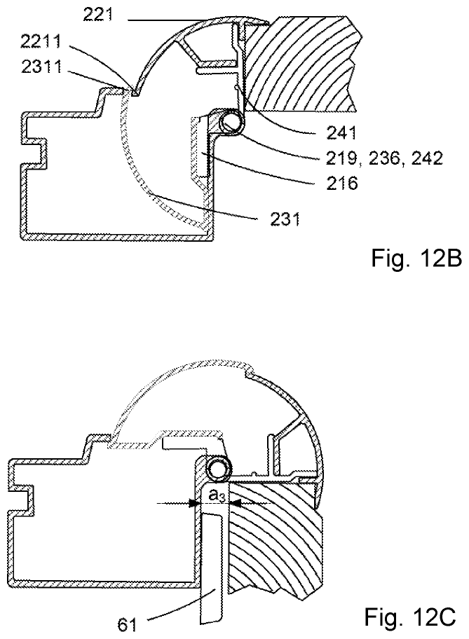

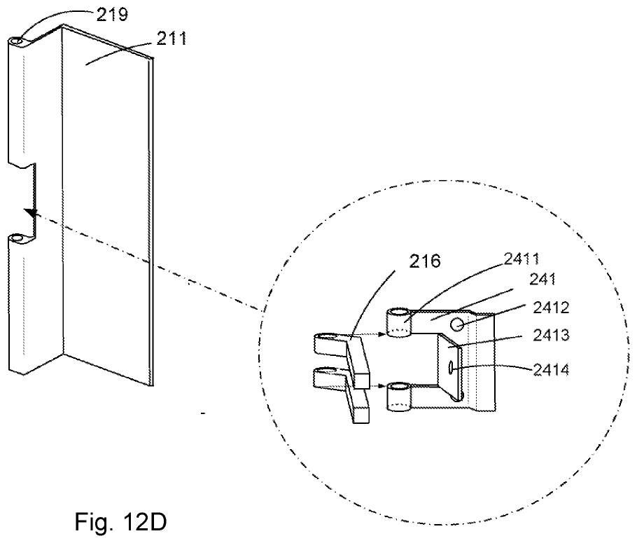

FIG. 12A shows the details from the FIGS. 11A-11C assembled as well as art of a door 251 with a back edge 252, the door being in a closed position. Within the cavity 212 in the frame reside both the cover 231 and within the latter the door blade adapter 221. A difference between this embodiment and the previous ones is that the door hinge 241 and the cover hinge 216 have a common pivotal axis, the bores 219, 236 and 2411 thus being coaxial in the assembled condition. Common with the previous embodiments is the external arrangement of the pivotal axis in relation to the cavity 212 defined by the door frame, thereby allowing 180 degrees opening of the door, even with a clearance that provides increased safety as well as the option of attachment of a list that at last partly covers the doorframe.

FIG. 12B shows the same as FIG. 12A but with the door opened 90 degrees. In the shown position, the door hinge 241 is rotated 90 degrees about its pivotal axis while the cover hinge is in same position as in FIG. 12A. The door blade adapter 221 is thereby pulled out from the cavity in the doorframe while the cover 231 is still inside the frame. It is, however, not important for the function of the door whether the cover hinge 216 starts to rotate before the door hinge 241 has rotated 90 degrees or not. As shown in FIG. 12B the outwardly oriented edge 2211 of the door blade adapter has come to rest against the inwardly oriented edge 2311 on the cover. A further opening of the door from the position shown in FIG. 12B will thus cause the cover to be pulled out from the frame cavity.

FIG. 12C shows an opening of the door to 180 degrees. Here, also the cover has been pulled out of the frame and the cover hinge has rotated 90 degrees. A shown by FIG. 12C, even with 180 degrees opening of the door, there is a distance a₃ between the door and the doorframe which contributes to increased safety in the form of reduced risk for squeeze injuries and the option to mount a list that partly covers the door frame.

FIG. 12D shows in perspective a section of two “walls” of a door frame 211 according to the embodiment shown in the FIGS. 11 and 12. The figure illustrates the fact door hinges can be arranged at any height of the doorframe by cutting out sections where it is desirable to mount door hinges 241 and a cover hinges 216. It is of particular relevance for heavier doors to have the possibility of attaching more than two hinges to the door.

Furthermore, FIG. 12D shows schematically a door hinge 241 having two ears with bores 2411 at a distance from one another as well as two cover hinges 216 for which space is saved between the two ears of the door hinge. The door hinge has typically at least two holes 2412 for attachment to a door and an upwards extending flange 2413 with a hole 2414 through which a screw can be attached to a door blade adapter 221.

With the embodiment shown in the FIGS. 11 and 12 there will typically be one door hinge near upper end of the door, one door hinge near the lower end of the door and optionally one or more door hinges in between the upper and the lower door hinge.

All discussed embodiments describe an assembly of a door 51 and door frame 10, 100, 200, the door 51, 151, 251 at a first vertical edge, hereinafter called the back edge 52, 152, 252 is hinged to a first side of the doorframe, hereinafter called the doorframe hinge side 11, 111, 211 using door hinges 41, 141, 241 up and down, while the door frame hinge side 11, 111, 211 is designed with a cavity 12, 112, 212 and that a cover 31, 131, 231 is rigidly attached to the door hinges at top and bottom, the cover 31, 131, 231 exhibiting a bore 36, 136, 236 pivotally attached to the cover hinges 16, 116, 216 with vertical pivotal axis on the doorframe hinge side 11, 121, 211, having a dimension adapted to be received in the cavity 12, 112, 212 in the door frame hinge side when the door 51, 151, 251 is closed, having a curvature with a convex outer surface 35, 135, 235 with the shape of a segment of a cylinder surface constituting part of a vertical imaginary cylinder 310, the bore 36, 136 being positioned so that it forms a centre axis in said imaginary cylinder 310. Among further characteristic features is the fact that the bore 36, 136, 236 is positioned so that it forms a centre axis in an imaginary cylinder 310 and that said centre axis is external of the cavity 12, 112, 212.

It should be understood that the examples above are just examples. Thus, modifications can be made within the scope of the inventive embodiments as defined by the claims.

The door blade adapter, for example, may be omitted entirely if a door blade as such is shaped with a profile and attachment device that functionally cooperates with frame and door hinge as described.

The cover hinge 16 is rigidly attached to the doorframe hinge side and allows the door to rotate in relation to the frame hinge side since the cover 31, attached to the door, is pivotally attached about the vertical axis defined by the cover hinge.

The door hinge is rigidly attached to the door and allows the door to rotate in relation to the frame hinge side by a rotation of the door hinge about its hole 42, which is arranged concentrically with the bore 22 at the back edge of the door. The bore 22 can be a bore in the door blade as such or a bore in a door blade adapter 21 attached to the back edge of the door as described.

The pivotal axis defined by 22, 42, 36 are mutually parallel and in proximity of one another but not mutually concentric with one another.

1-10. (canceled)

11. An assembly of a door (51, 151, 251) and a doorframe (10, 100, 200), comprising:
a door (51, 151, 251) having a first vertical edge defining a back edge (52, 152, 252); and
a doorframe (10, 100, 200) having a first side defining the doorframe hinge side (11, 111, 211) with door hinges (41, 141, 241), the doorframe hinge side (11, 111, 211) including a cavity (12, 112, 212); and
a cover (31, 131, 231) fixed to the door hinges (41, 141, 241) up and down, wherein
the cover (31, 131, 231) has a bore (36, 136, 236) pivotally attached to cover hinges (16, 116, 216) with a vertical pivotal axis at the doorframe hinge side (11, 111, 211),
the cover is dimensioned to be received in the cavity (12, 112, 212) in the doorframe hinge side (11, 111, 211) when the door (51, 151, 251) is closed,
the cover has a curvature with a convex outer surface (35, 135, 235) with a contour forming a partial circumference of an imaginary cylinder (310), and
the bore (36, 136, 236) is positioned to form a center axis of the imaginary cylinder (310), and said imaginary cylinder (310) and that said center axis is positioned outside the cavity (12, 112, 212).

12. The assembly of a door (51, 151, 251) and a doorframe (10, 100, 200) as claimed in claim 11, wherein the doorframe hinge side (11, 111, 211) is formed as an extruded profile with a common horizontal cross-section at all vertical levels.

13. The assembly of a door (51, 151, 251) and a doorframe (10, 100, 200) as claimed in claim 11, wherein the door (51, 151, 251) is pivotally arranged for opening approximately 90 degrees via the door hinges (41, 141, 241).

14. The assembly of a door (51, 151, 251) and a doorframe (10, 100, 200) as claimed in claim 12, wherein the door (51, 151, 251) is pivotally arranged for opening approximately 90 degrees via the door hinges (41, 141, 241).

15. The assembly of a door (51, 151, 251) and a doorframe (10, 100, 200) as claimed in claim 11, wherein the door (51, 151, 251) is pivotally arranged for opening to an angle of greater than 90 degrees via the cover hinges (16, 116, 216).

16. The assembly of a door (51, 151, 251) and a doorframe (10, 100, 200) as claimed in claim 12, wherein the door (51, 151, 251) is pivotally arranged for opening to an angle of greater than 90 degrees via the cover hinges (16, 116, 216).

17. The assembly of a door (51, 151, 251) and a doorframe (10, 100, 200) as claimed in claim 13, wherein the door (51, 151, 251) is pivotally arranged for opening to an angle of greater than 90 degrees via the cover hinges (16, 116, 216).

18. The assembly of a door (51, 151, 251) and a doorframe (10, 100, 200) as claimed in claim 11, wherein the door (51, 151, 251) is pivotally arranged for opening approximately 180 degrees.

19. The assembly of a door (51, 151, 251) and a doorframe (10, 100, 200) as claimed in claim 12, wherein the door (51, 151, 251) is pivotally arranged for opening approximately 180 degrees

20. The assembly of a door (51, 151, 251) and a doorframe (10, 100, 200) as claimed in claim 11, comprising a flange (117, 217) attached to the doorframe hinge side and a stop flange (137, 237) on the cover, the flange (117, 217) and stop flange (137, 237) cooperating to stop the movement of the cover out from the cavity (112, 212) at a desired maximum opening position of the door (152, 251).

21. The assembly of a door (51, 151, 251) and a doorframe (10, 100, 200) as claimed in claim 12, comprising a flange (117, 217) attached to the doorframe hinge side and a stop flange (137, 237) on the cover, the flange (117, 217) and stop flange (137, 237) cooperating to stop the movement of the cover out from the cavity (112, 212) at a desired maximum opening position of the door (152, 251).

22. The assembly of a door (51, 151, 251) and a doorframe (10, 100, 200) as claimed in claim 13, comprising a flange (117, 217) attached to the doorframe hinge side and a stop flange (137, 237) on the cover, the flange (117, 217) and stop flange (137, 237) cooperating to stop the movement of the cover out from the cavity (112, 212) at a desired maximum opening position of the door (152, 251).

23. The assembly of a door (51, 151, 251) and a doorframe (10, 100, 200) as claimed in claim 11, the door (51, 151) at its back edge (52, 152) being formed with a convex curvature (25, 125), the convex curvature (25, 125) at the door's back edge being selected among a curvature on the door blade as such and a curvature on a door blade adapter (21, 121) attached to the door's back edge (52, 152).

24. The assembly of a door (51, 151, 251) and a doorframe (10, 100, 200) as claimed in claim 12, the door (51, 151) at its back edge (52, 152) being formed with a convex curvature (25, 125), the convex curvature (25, 125) at the door's back edge being selected among a curvature on the door blade as such and a curvature on a door blade adapter (21, 121) attached to the door's back edge (52, 152).

25. The assembly of a door (51, 151, 251) and a doorframe (10, 100, 200) as claimed in claim 13, the door (51, 151) at its back edge (52, 152) being formed with a convex curvature (25, 125), the convex curvature (25, 125) at the door's back edge being selected among a curvature on the door blade as such and a curvature on a door blade adapter (21, 121) attached to the door's back edge (52, 152).

26. The assembly of a door (51, 151, 251) and a doorframe (10, 100, 200) as claimed in claim 11, comprising a flange (15) in the doorframe hinge side (11) positioned adjacent an opening into the cavity (12), wherein the flange (15) has a portion with a concave outer surface (35) that matches the convexity of the cover (31).

27. The assembly of a door (51, 151, 251) and a doorframe (10, 100, 200) as claimed in claim 12, comprising a flange (15) in the doorframe hinge side (11) positioned adjacent an opening into the cavity (12), wherein the flange (15) has a portion with a concave outer surface (35) that matches the convexity of the cover (31).

28. An assembly of a door (251) and a doorframe as claimed in claim 11, wherein
the door back edge (252) includes a door blade adapter (221) with a curvature substantially the same as the surface of the cover (231),
the door blade adapter is arranged to rotate out of an inner cavity (2312) of the cover (231) when the door is opened more than 90 degrees, the rotation of the door blade adapter being about a pivotal axis (236) common with the pivotal axis (236) of the cover hinges (216),
the door blade adapter (221) and the cover (231) include outer part cylindrical surfaces (225, 235) that respectively form a sealing at the back edge of the door and hinges in any open position of the door up to 180 degrees opening.

29. The assembly of a door (251) and a doorframe as claimed in claim 28, comprising a flange (217) attached to the doorframe hinge side and a stop flange (237) on the cover, the flange (217) and stop flange (237) cooperating to stop the movement of the cover out from the cavity (212) at a desired maximum opening position of the door (251).

30. The assembly of a door (251) and a doorframe as claimed in claim 28, comprising a door hinge proximate the upper end of the door, a door hinge proximate the lower end of the door.
